(19) United States
(12) Patent Application Publication
(10) Pub. No.: US 2017/0144282 A1
(43) Pub. Date: May 25, 2017

(54) PNEUMATIC PULSE TOOL WITH SHUT-OFF MECHANISM

(71) Applicant: ATLAS COPCO INDUSTRIAL TECHNIQUE AB, Stockholm (SE)

(72) Inventors: Per Thomas SÖDERLUND, Värmdö (SE); Fernando Nicolas VIDAL LERCHE, Solna (SE)

(73) Assignee: ATLAS COPCO INDUSTRIAL TECHNIQUE AB, Stockholm (SE)

(21) Appl. No.: 15/309,605

(22) PCT Filed: May 20, 2015
(86) PCT No.: PCT/EP2015/061075

§ 371 Date: Nov. 8, 2016

(30) Foreign Application Priority Data
May 28, 2014 (SE) 1450642-2

(51) Int. Cl. B25B 23/145; B25B 21/02

(52) U.S. Cl. CPC B25B 23/1453; B25B 21/02

(57) ABSTRACT

A pneumatic torque impulse delivering power tool with an automatic power shut-off mechanism including: a pneumatic motor, a drive member rotatable by the pneumatic motor, an air supply channel, with a shut-off valve, for providing pressurized air, and a valve control device that can shut the shut-off valve and stop the air flow when the drive member is exposed to a retardation magnitude above a certain threshold level. The valve control device includes: an inertia responsive member rotatable with the drive member between initial and shut-off positions in which the shut-off valve cannot and can close, respectively, and an air damped movement restrictor which can counteract a movement of the inertia responsive member towards its shut-off position such that the shut-off valve is shut when the drive member is exposed to a retardation magnitude above a certain threshold level corresponding to a dampening force of the air damped movement restrictor.

### TECHNICAL FIELD OF THE INVENTION

This invention relates to a pneumatic torque impulse tool for tightening screw joints and including an automatic power shut-off means. In particular, the invention concerns a torque impulse tool of the type comprising a housing, a hydraulic impulse generator, a pneumatic motor with a rotor drivingly coupled to the impulse generator, wherein the shut-off means includes an air inlet valve communicating with the motor and adjustable between an open condition and a closed condition, and a retardation responsive activation means that rotates with the rotor and including an inertia actuator, and a connection member coupling the inlet valve to the activation means for shifting the inlet valve from the open condition to the closed condition when activated by the activation means when a predetermined maximum retardation magnitude level is reached.

### BACKGROUND

Torque delivering pulse power tools include a pulse unit that intermittently connects a motor shaft to an output shaft that is arranged to hold a tool implement. The pulse unit comprises a housing in which a cylinder is arranged to rotate. The cylinder is driven by a shaft that is driven by a motor, directly or via a gear. An anvil is arranged inside the cylinder and is intermittently driven, i.e. in pulses, by the cylinder.

Together the cylinder and the anvil form a pulse unit. There are different types of pulse units. There are e.g. piston pulse units and there are vane pulse units. In both these types a non-compressible, or close to non-compressible, hydraulic fluid is utilised as an intermediate in the generation of pulses between the components of the pulse unit.

Some pulse tools are provided with a shut-off mechanism. The shut-off mechanism stops the tool from delivering pulses when a set torque level has been reached in a joint that is being tightened. Generally, the shut-off mechanism comprises an inertia body-spring configuration, in which a spring provides a counter force on an inertia body. At the retardation of the cylinder the inertia body will be forced in one direction by its own inertia, which will be opposed by the spring action. When the inertia exceeds a certain threshold corresponding to the spring constant and the current pretension of the spring the inertia body will act on a shut-off mechanism whereby the pulsing will be terminated, e.g. by shutting off the motor. The spring position may be altered so as to set the shut-off threshold to correspond to a desired torque level.

A previously known torque impulse tool of this type is described in U.S. Pat. No. 5,082,066.

A problem in this and other conventional shut-off mechanisms is inter alia the reliability of the mechanism. The spring action may vary over time due to a number of reasons including uncontrolled friction, buckling and twisting of the spring.

Hence, there is a need of a shut-off mechanism that is more reliable than a conventional spring controlled shut-off mechanism, but which is relatively uncomplicated in production and implementation.

### SUMMARY OF THE INVENTION

An object of the invention is to provide a pneumatic power tool with a shut-off mechanism that is more reliable than known mechanisms.

This object is achieved by the invention according to claim 1, which relates to a pneumatic torque impulse delivering power tool with an automatic power shut-off mechanism, the power tool comprising:
a pneumatic motor;
a drive member which is driven to rotate by said pneumatic motor,
an air supply channel for providing the motor with pressurized air;
a valve arranged in said air supply channel; and
a valve control device arranged to shut said valve and stop the air flow to the pneumatic motor when the drive member is exposed to a retardation magnitude above a certain threshold level, wherein the valve control device comprises an inertia responsive member, which is arranged to rotate along with the drive member, and which is rotatable between an initial position in which it does not interfere with the valve and a shut-off position in which it allows the valve to close. The valve control device further comprises an air damped movement restrictor arranged to counteract the movement of the inertia responsive member towards the shut-off position, such that the valve is only shut when the drive member is exposed to a retardation magnitude above a certain threshold level corresponding to a dampening force of the air damped movement restrictor.

With the power tool according to the invention a shut-off mechanism is achieved, which is reliable and which has a simple construction that offers good adjustability possibilities.

Other features and advantages of the invention will be apparent from the dependent claims and from the detailed description of the shown embodiment.

### SHORT DESCRIPTION OF THE DRAWINGS

In the following detailed description reference is made to the accompanying drawings, of which:

FIG. 1 shows a pneumatic power tool in accordance with a specific embodiment of the invention;

FIG. 2 shows a perspective view of a drive member of the power tool in FIG. 1;

FIG. 3 shows a side view of the drive member in FIG. 2; and

FIG. 4 shows a sectional view along the line IV-IV in FIG. 3;

### DETAILED DESCRIPTION OF THE SHOWN EMBODIMENT OF THE INVENTION

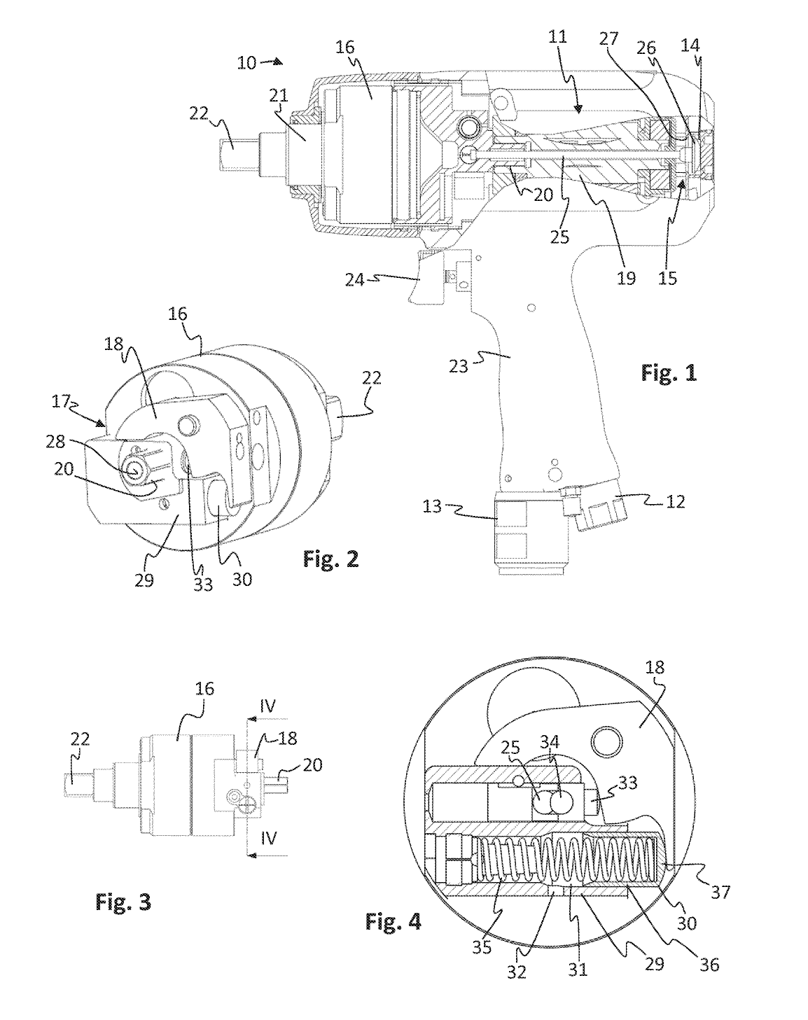

In FIG. 1 a pneumatic torque impulse delivering power tool 10 with an automatic power shut-off mechanism is shown. The power tool 10 comprises a pneumatic motor 11 that is driven by pressurized air. An air inlet portion 12 is arranged for connection to a pressurized air supply, and an air outlet portion 13 is arranged for exhausting air from the motor. An air supply channel 14 for providing the motor 11 with pressurized air is arranged and includes a shut-off valve 15.

Further, the power tool 10 includes a drive member 16 which is driven to rotate by means of said pneumatic motor 11. The drive member is connected to a rotor 19 of the motor 11, via a hexagonal connection 20. The drive member 16 intermittently drives an anvil 21, which is partly located inside the drive member 16, extends through a front part of the drive member, and is integrally connected to an output shaft 22. Further, the shown power tool 10 comprises a handle 23 and a trigger 24 for regulating the inflow of pressurised air.

The drive member 16 is shown in a perspective view in FIG. 2. A valve control device 17 is arranged on the drive member 16 to shut said shut-off valve 15 and stop the air flow to the pneumatic motor 11 when the drive member 16 is exposed to a retardation magnitude above a certain threshold level. The valve control device 17 comprises an inertia responsive member 18, which is arranged to rotate along with the drive member 16, and which is pivotally arranged with respect to the drive member 16. The inertia responsive member 18 may pivot between an initial position in which it does not allow the shut-off valve 15 to close and a shut-off position in which it allows the shut-off valve 15 to close. The shut-off valve 15 is actuated via an actuation pin 25 that runs through the centre of the rotor 19 and is connected to a valve element 26 of the valve 15. Actuation of the valve control device 17 will bring the valve element 26 into fluid tight contact with a valve seat 27 so as to close the valve 15. See FIG. 1. When the valve control device 17 so allows, the valve element 26 will be forced into the closed position by the action of the pressurised air in the air supply channel 14. A spring (not shown) is preferably arranged to act on the valve element so as to push the valve element 26 to its open position as the trigger 24 is closed and the pressure is relieved in the air supply channel 14.

As is visible in FIG. 2 the valve control device 17 is arranged at the back end the drive member 16. In the central back portion of the drive member 16 the hexagonal connection 20 for connection to the rotor is visible. In the centre of the hexagonal connection 20 a bore 28 is arranged. The actuation pin 25 (see FIG. 1) is arranged to run through the bore 28.

The interaction of the drive member 16 and the valve control device 17 is such that the drive member 17 is driven by the rotor 19 of the motor 11 to rotate clockwise with respect to the view in FIG. 2. When the drive member 17 is being retarded due to power transmission to the anvil 21 and the output shaft 22 the inertia responsive member 18 will, due to its inherent inertia, be urged to continue its rotation.

Now, the function of the invention will be described with reference to FIG. 4, which is a sectional view of the drive member 16 along the line IV-IV in FIG. 3.

The valve control device 17 comprises an air damped movement restrictor 29 arranged to counteract the movement of the inertia responsive member 18 towards the shut-off position. The shut-off valve 15 will only shut when the drive member 16 is exposed to a retardation magnitude above a certain threshold level corresponding to a dampening force of the air damped movement restrictor 29.

When the retardation magnitude of the inertia responsive member 18 exceeds the dampening force of the air damped movement restrictor 29 the inertia responsive member 18 will be allowed to rotate with respect to the drive member 16 into the shut-off position in which it pushes an actuation piece 33 inwards such that a recess 34 will be positioned in alignment with position of the actuation pin 25. Thereby, the actuation pin 25 will be allowed to enter the recess 34 such that the shut-off valve 15 will be shut and the air flow to the rotor 19 will be interrupted.

In the shown embodiment the air damped movement restrictor 29 comprises an air tight cylindrical hat 30 arranged to slide inside an air chamber 31. During retardation of the drive member 16 the inertia responsive member 18 acts in a direction upon the cylindrical hat 30 so as to compress the air inside the air chamber 31. At this point the pressure of the air inside the air chamber 31 provides the dampening force that counteracts the movement of the inertia responsive member towards the shut-off position.

As is visible in FIG. 4 a duct 32 is arranged from the air chamber 31. The duct 32 may function as a restriction valve that only releases air from the air chamber at a certain resistance so as to limit the air flow out from the air chamber 31. Further, the duct 32 may be adjustable so as to control the flow through it and to adapt the flow to a specific threshold that corresponds to a specific retardation force on the inertia responsive member 18, which in turn corresponds to a specific delivered torque by the anvil 21.

It is also possible to convey pressurized air from the air supply channel 14 to the air chamber 31 to pressurize the air inside the air chamber 31 and push the cylindrical hat 30 in the direction that counteracts the movement of the inertia responsive member 18. The duct would in such an embodiment include a proportional valve that could be set to adjust the air pressure inside the air chamber 31 in proportion to the air pressure in the air supply channel 14 and thereby provide a desired air pressure inside the air chamber 31 that represents a desired counter force to the inertia responsive member 18. The possibility to pressurize the air inside the air chamber is also useful in that it will make it possible to reset the cylindrical hat 30 towards its initial position.

In the shown embodiment the valve control device 17 comprises a spring 35 arranged to act on the inertia responsive member 18 towards its initial position, such that, in addition to the dampening force of the air damped movement restrictor 29, a spring action of the spring 35 needs to be overcome by the retardation force acting on the inertia responsive member 18 in order to move the inertia responsive member 18 into the shut-off position so as to close the valve.

An advantage of having two parallel systems is that it makes the system more reliable and less prone to variations. Specifically, every type of mechanical features will include performance deviations typically following a standard deviation curve. Hence, for a spring, the spring action will due to natural fluctuations lie within an acceptable interval most of the time but for a certain percentage of spring operations the spring action will be lower than an acceptable minimum level which may lead to a premature shut-off of the pneumatic motor. The opposite may also happen, i.e. that the motor is not shut off even though a threshold torque has been met.

The dampening effect of an air damped movement restrictor will also follow a standard deviation curve. However, if the two are combined the sum of deviation of the joint spring and air dampener will for most parts be evened out such that the joint counter force delivered by the spring and the air damped movement restrictor will be within an acceptable interval for a higher percentage than for either of the single systems.

In the shown embodiment the spring 35 is arranged in the air chamber 31 to act outwards on the cylindrical hat 30. The cylindrical hat 30 comprises a tubular portion 36 in which the spring 35 fits and is supported from bending and an end portion 37 that supports the end of the spring 35 and delimits the volume of the air chamber 31. Hence, when the inertia responsive member 18 acts on the air damped movement restrictor 29 it has to overcome both the spring action of the spring 35 and the dampening force of the air damped movement restrictor 29.

Above, the invention has been described with reference to a specific embodiment. The invention is however not limited to this embodiment. It is obvious to a person skilled in the art that the invention comprises further embodiments within its scope of protection, which is defined by the following claims.

1-7. (canceled)

8. A pneumatic torque impulse delivering power tool with an automatic power shut-off mechanism, the power tool comprising:
a pneumatic motor;
a drive member driven to rotate by the pneumatic motor;
an air supply channel for providing the pneumatic motor with pressurized air;
a shut-off valve arranged in the air supply channel; and
a valve control device arranged to shut the shut-off valve and stop the air flow to the pneumatic motor when the drive member is exposed to a retardation magnitude above a certain threshold level, wherein the valve control device comprises:
an inertia responsive member arranged to rotate along with the drive member, and pivotally arranged with respect to the drive member between an initial position in which it does not allow the shut-off valve to close and a shut-off position in which it allows the shut-off valve to close; and
an air damped movement restrictor arranged to counteract a movement of the inertia responsive member towards its shut-off position such that the shut-off valve is only shut when the drive member is exposed to a retardation magnitude above a certain threshold level corresponding to a dampening force of the air damped movement restrictor.

9. The pneumatic torque impulse delivering power tool according to claim 8, wherein:
the air damped movement restrictor comprises an air tight cylindrical hat arranged to slide inside an air chamber; and
the inertia responsive member acts in a direction upon the cylindrical hat so as to compress the air in the air chamber, and wherein the pressure of the air inside the air chamber provides the dampening force that counteracts the movement of the inertia responsive member towards the shut-off position.

10. The pneumatic torque impulse delivering power tool according to claim 9, wherein a duct is arranged to allow a restricted flow of air out from the air chamber.

11. The pneumatic torque impulse delivering power tool according to claim 10, wherein the duct comprises an adjustable valve by means of which it is possible to control the flow of air out from the air chamber.

12. The pneumatic torque impulse delivering power tool according to claim 10, wherein the duct comprises a passage that connects the air chamber to the air supply channel in order to selectively convey pressurized air from the air supply channel to the air chamber to pressurize the air inside the air chamber and push the cylindrical hat in the direction that counteracts the movement of the inertia responsive member.

13. The pneumatic torque impulse delivering power tool according to claim 8, wherein the valve control device further comprises a spring arranged to act on the inertia responsive member towards the initial position, such that, in addition to the dampening force of the air damped movement restrictor, a spring action of the spring needs to be overcome by the retardation force acting on the inertia responsive member in order to move the inertia responsive member into the shut-off position so as to close the shut-off valve.

14. The pneumatic torque impulse delivering power tool according to claim 9, wherein the valve control device further comprises a spring arranged to act on the inertia responsive member towards the initial position, such that, in addition to the dampening force of the air damped movement restrictor, a spring action of the spring needs to be overcome by the retardation force acting on the inertia responsive member in order to move the inertia responsive member into the shut-off position so as to close the shut-off valve.

15. The pneumatic torque impulse delivering power tool according to claim 10, wherein the valve control device further comprises a spring arranged to act on the inertia responsive member towards the initial position, such that, in addition to the dampening force of the air damped movement restrictor, a spring action of the spring needs to be overcome by the retardation force acting on the inertia responsive member in order to move the inertia responsive member into the shut-off position so as to close the shut-off valve.

16. The pneumatic torque impulse delivering power tool according to claim 11, wherein the valve control device further comprises a spring arranged to act on the inertia responsive member towards the initial position, such that, in addition to the dampening force of the air damped movement restrictor, a spring action of the spring needs to be overcome by the retardation force acting on the inertia responsive member in order to move the inertia responsive member into the shut-off position so as to close the shut-off valve.

17. The pneumatic torque impulse delivering power tool according to claim 12, wherein the valve control device further comprises a spring arranged to act on the inertia responsive member towards the initial position, such that, in addition to the dampening force of the air damped movement restrictor, a spring action of the spring needs to be overcome by the retardation force acting on the inertia responsive member in order to move the inertia responsive member into the shut-off position so as to close the shut-off valve.

18. The pneumatic torque impulse delivering power tool according to claim 14, wherein the spring is arranged inside the air chamber to act outwards on the cylinder hat, and wherein the cylindrical hat comprises a tubular portion in which the spring fits tightly so as to be supported from bending and an end portion that supports an end of the spring and delimits a volume of the air chamber.
